(19) United States
(12) Patent Application Publication
(10) Pub. No.: US 2018/0089088 A1
(43) Pub. Date: Mar. 29, 2018

(54) APPARATUS AND METHOD FOR PERSISTING BLOCKS OF DATA AND METADATA IN A NON-VOLATILE MEMORY (NVM) CACHE

(71) Applicant: INTEL CORPORATION, Santa Clara, CA (US)

(72) Inventors: Andrzej JAKOWSKI, Chandler, AZ (US); Kapil KARKRA, Chandler, AZ (US); Igor KONOPKO, Gdansk (PL); Sanjeev N. TRIKA, Portland, OR (US); Knut S. GRIMSRUD, Forest Grove, OR (US)

(21) Appl. No.: 15/278,022

(22) Filed: Sep. 27, 2016

(51) Int. Cl. G06F 12/0864; G06F 3/06; G06F 11/14

(52) U.S. Cl. CPC G06F 12/0864; G06F 3/0619; G06F 3/0656; G06F 2201/84; G06F 3/0683; G06F 11/1469; G06F 2212/222; G06F 3/0659

(57) ABSTRACT

Provided are an apparatus and method for persisting blocks of data and metadata in a non-volatile memory (NVM) cache. A non-volatile memory (NVM) cache caches blocks of data from the storage of the first block size and metadata for each of the cached blocks of data indicating a status of the cached block of data, including whether the block of data is modified or unmodified, and a location in the storage where the block of data is stored. The non-volatile memory has blocks of a second block size greater than the first block size, wherein one of the blocks in the non-volatile memory stores the block of data from the storage and the metadata for the block of data. A cache manager writes the block of data and the metadata for the block of data to one of the blocks in the non-volatile memory cache and writes the block of data in one of the blocks in the non-volatile memory cache to the storage.

### TECHNICAL FIELD

Embodiments described herein generally relate to an apparatus and method for persisting blocks of data and metadata in a non-volatile memory (NVM) cache.

### BACKGROUND

In current host side caching solutions, caching devices, such as Dynamic Random Access Memory (DRAM) devices and Solid State Disks (SSDs), can cache data for a storage array, such as an array of hard disk drives. Caching systems maintain modified data in the cache by mapping logical block addresses in the storage device to cache lines, writing data in the cache lines to a second non-volatile cache, such as an SSD, writing the metadata to the second non-volatile cache for blocks written to the second non-volatile cache, and then returning complete after both the block of data and metadata are written to the second non-volatile cache. Writing user blocks and metadata in cache to the second non-volatile cache is required for a write-back cache when dirty data is inserted into the cache to provide for recovery from a power failure. In the event of a power failure, a recovery/rebuild procedure can recover dirty user data from the second non-volatile cache and write it to the primary storage device, since cache metadata is available on the second non-volatile cache. The metadata provides the critical mapping information on the status of the data in the cache line, such as whether the cache line is clean or dirty. Typically, the metadata is located at the beginning or the end of the second non-volatile cache, such as an SSD.

There is a need in the art for improved techniques for managing modified data and metadata in caching devices.

### BRIEF DESCRIPTION OF THE DRAWINGS

Embodiments are described by way of example, with reference to the accompanying drawings, which are not drawn to scale, in which like reference numerals refer to similar elements.

FIG. 1 illustrates an embodiment of a caching system.

FIG. 2 illustrates an embodiment of a cache line.

FIG. 3 illustrates an embodiment of a read data only command.

FIG. 4 illustrates an embodiment of a write data only command.

FIG. 5 illustrates an embodiment of a read metadata only command.

FIG. 6 illustrates an embodiment of a write metadata only command.

FIG. 7 illustrates an embodiment of a read data and metadata command.

FIG. 8 illustrates an embodiment of a write data and metadata command.

FIG. 9 illustrates an embodiment of operations to write data in the cache to the NVM cache in an interleaved mode.

FIG. 10 illustrates an embodiment of operations to process a write data and metadata command in an interleaved mode.

FIG. 11 illustrates an embodiment of operations to write data in the cache to the NVM cache in a non-interleaved mode.

FIG. 12 illustrates an embodiment of operations to process a write data and metadata command in non-interleaved mode.

FIG. 13 illustrates an embodiment of operations to synchronize the NVM cache with storage.

FIG. 14 illustrates an embodiment of operations to process a read metadata only command.

FIG. 15 illustrates an embodiment of operations to process a read data only command.

FIG. 16 illustrates an embodiment of operations to process a write data only command.

FIG. 17 illustrates an embodiment of operations to process a write metadata only command.

### DESCRIPTION OF EMBODIMENTS

Described embodiments provide a non-volatile memory (NVM) cache to cache data for a storage, where the NVM cache supports extended size blocks larger than a standard size block of blocks stored in a storage for which data is being cached by the NVM cache. The extended size blocks in the NVM cache may store both blocks of data from the storage, having the standard first size block, and metadata for the blocks of data. Further, when storing both user blocks of data, of a first or standard sector size, e.g., 512 bytes or 4 KB, and metadata together in a larger second (extended) size block configured for logical addresses in the NVM cache, read and write commands may be provided that access blocks of data and/or metadata from the second size blocks having both blocks of data and metadata.

By allowing for metadata only reads and only writes, data transfer time and resource consumption for synchronization operations is substantially less than systems that read the blocks of data with their metadata. Yet further, since metadata and blocks of data may be written into the NVM cache, such as an SSD, in a single atomic operation, performance is improved while maintaining power fail safety because both the blocks of data and their metadata are preserved in the NVM cache in an atomic operation.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Certain embodiments relate to storage device electronic assemblies. Embodiments include both devices and methods for forming electronic assemblies.

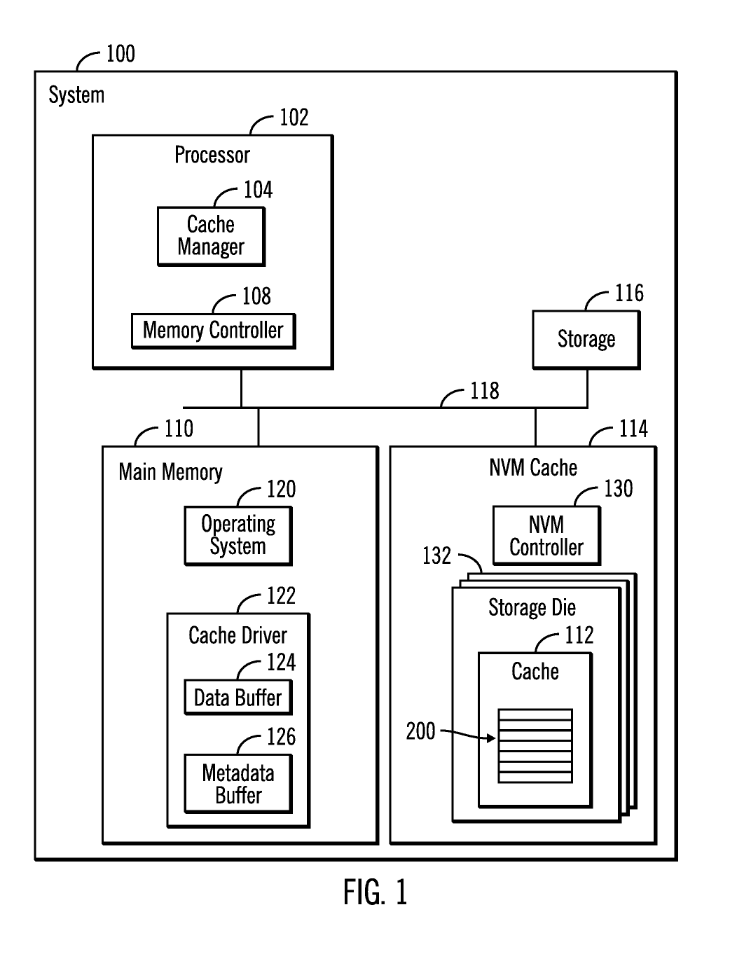

FIG. 1 illustrates an embodiment of a system 100 having a processor 102, a cache manager 104, and a memory controller 108 to interface with a main memory 110 in which programs used by the processor 102 are stored. The cache manger 104 may also communicate with a non-volatile memory (NVM) cache 114 and a storage 116, where the NVM cache 114 caches data in the storage 116. The cache manager 104 may access the main memory 110, the NVM cache 114, and the storage 116 over an interface 118, such as a Peripheral Component Interconnect (PCI) bus, Peripheral Component Interconnect express (PCIe) bus, Serial ATA (SATA) bus, Small Computer System Interface (SCSI), e.g., T10, T13, etc., or other suitable custom or standard bus interface.

The NVM cache 114 provides a cache memory for data in the storage 116. A cache mapping may be used to map the cached data in the NVM cache 114 to the block addresses in the storage 116.

The NVM cache 114 may be comprised of a solid state drive (SSD) or other type of non-volatile memory device allowing for an extended sector size to store at logical addresses both user data and metadata. For instance, the NVM cache 114 may comprise non-volatile memory types, such as a Flash Memory (NAND dies of flash memory cells), a non-volatile dual in-line memory module (NVDIMM), DIMM, Static Random Access Memory (SRAM), ferroelectric random-access memory (FeTRAM), nanowire-based non-volatile memory, three-dimensional (3D) cross-point memory, phase change memory (PCM), memory that incorporates memristor technology, Magnetoresistive random-access memory (MRAM), Spin Transfer Torque (STT)-MRAM and other electrically erasable programmable read only memory (EEPROM) type devices.

The cache manager 104 determines whether data requested by the processor 102 is in the NVM cache 114, and if not, the cache manager 104 fetches the requested data from the storage 116 to stage into the NVM cache 114. If the requested data is in the NVM cache 114, then it is returned from the faster access NVM cache 114.

The system 100 may also communicate with Input/Output (I/O) devices, which may comprise input devices (e.g., keyboard, touchscreen, mouse, etc.), display devices, graphics cards, ports, network interfaces, etc.

In FIG. 1, the storage 116 is shown as connected to the system bus 118. In alternative embodiments, the storage 116 may comprise one or more storage devices external to the system 100, such as connected to the system over a network, e.g., Network Attached Storage, storage server, etc. The storage 116 may comprise a slower access storage than the NVM cache 114 and may comprise one or more hard disk drives configured as a Redundant Array of Independent Disks (RAID) array or Just a Bunch of Disks (JBOD). The storage 116 may also comprise other types of storage devices, such as SSDs, tape storage, etc.

In certain embodiments, the block of data in the cache 200 lines and for the logical addresses in the storage 116 may comprise a standard sector size of data, such as 512 bytes or 4Kb (4096 bytes). The NVM cache 114 may comprise a SSD implementing an extended sector or block size greater than the standard block size. One example of an SSD implementing such an extended sector size is the variable sector size feature of DC P3700 SSDs produced by Intel Corporation.

The main memory 110 stores an operating system 120 executed by the processor and a cache driver 122 used to communicate with the NVM cache 114 via commands sent over the bus 118, and includes a data buffer 124 and a metadata buffer 126 used to transfer blocks of data and metadata for the cache lines 200 in the NVM cache 114. The cache driver 122 may be part of or separate from the operating system 120.

The NVM cache 114 includes an NVM controller 130 to execute Input/Output (I/O) commands to transfer blocks of data between the cache manager 104 and a plurality of storage dies 132, implementing storage cells that may be organized into pages of storage cells, where the pages are organized into blocks. In an embodiment, the NVM cache 114 may comprise an SSD of NAND storage dies 132. The NVM controller 130 performs logical-to-physical mapping and provides a mapping of logical addresses to which I/O requests are directed and physical addresses in the storage dies 132. The cache 112 may be stored in one or more of the storage dies 132.

With the described embodiments, to transfer blocks of data and metadata, the cache manager 104 notifies the cache driver 122 of the logical address range to transfer, and the cache driver 122 handles the transfer to the NVM cache 114.

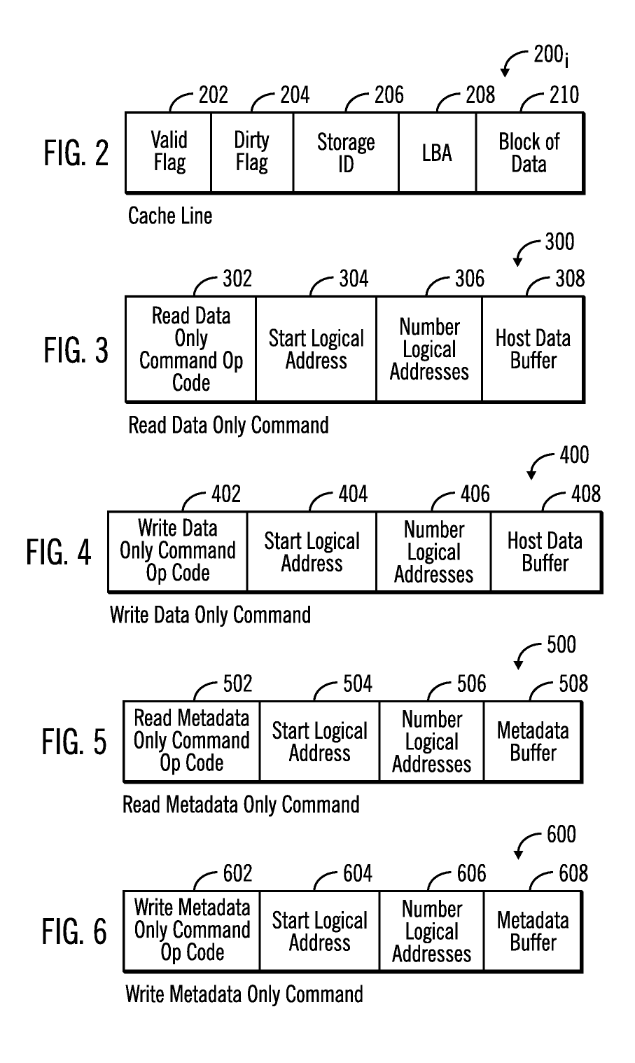

FIG. 2 illustrates an embodiment of one of the cache lines 200ᵢ at an index location in the cache lines 200 in the cache 200, and includes metadata comprising: a valid flag 202 indicating whether the cache line 200ᵢ has valid or invalid data; a dirty flag 204 indicating whether the cache line 200ᵢ has “dirty” data (e.g., data different from the data in the block in the storage 116, such as data modified in the cache 200) or “clean” data (e.g., data that is the same as the block in the storage 116, data that has not been modified since the block was last written to storage 116); a storage identifier (ID) 206 identifying a storage device in the storage 116 and logical block address (LBA) or logical address 208 of the data in the in the cache line in the storage 206. The cache line 200ᵢ further includes the block of data 210 for the logical address in the storage 206. Certain of the cache metadata 202, 204, 206, 208 may not be stored in the cache line 200ᵢ, and instead stored in the cache information 106. Further, the cache line 200ᵢ may include additional flags and bits to indicate different states of the cached block of data.

FIG. 3 illustrates an embodiment of a read data only command 300 the cache driver 122 may issue to read only the block of data from second (extended) size blocks of data in the NVM cache 114, storing both the block of data and metadata. The command 300 includes a read data only command operation (“OP”) code 302; a start logical address 304 in the NVM cache 114; a number of logical addresses 306 to read; and a pointer or identifier to the host data buffer 308 in the cache driver 122 to which the read data is transferred. The host data buffer 308 may include a pointer to a location in the data buffer 124 to which the read data is transferred.

FIG. 4 illustrates an embodiment of a write data only command 400 the cache driver 122 may issue to write only a block of data to the second (extended) size blocks of data in the NVM cache 114, storing both the block of data and metadata. The command 400 includes a write data only command operation code 402; a start logical address 404 in the NVM cache 114; a number of logical addresses 406 to write; and a pointer or identifier to the host data buffer 308 in the cache driver 122 including the write data to transfer to the NVM cache 114. The host metadata buffer 408 may include a pointer to a location in the metadata buffer 126 at which the write data to transfer is located.

FIG. 5 illustrates an embodiment of a read metadata only command 500 the cache driver 122 may issue to read only metadata from second (extended) size blocks of data in the NVM cache 114, storing both the block of data and metadata. The command 500 includes a read metadata only command operation code 502; a start logical address 504 in the NVM cache 114; a number of logical addresses 506 to read; and a pointer or identifier to the host metadata buffer 508 in the cache driver 122 to which the read metadata is transferred. The host metadata buffer 508 may include a pointer to a location in the buffer 126 to which the read metadata is transferred.

FIG. 6 illustrates an embodiment of a write metadata only command 600 the cache driver 122 may issue to write only metadata to the second (extended) size blocks of data in the NVM cache 114, storing both the block of data and metadata. The command 600 includes a write metadata only command operation code 602; a start logical address 604 in the NVM cache 114; a number of logical addresses 606 to write; and a pointer or identifier to the host metadata buffer 608 in the cache driver 122 including the write metadata to transfer to the NVM cache 114. The host metadata buffer 608 may include a pointer to a location in the metadata buffer 126 at which the write metadata to transfer is located.

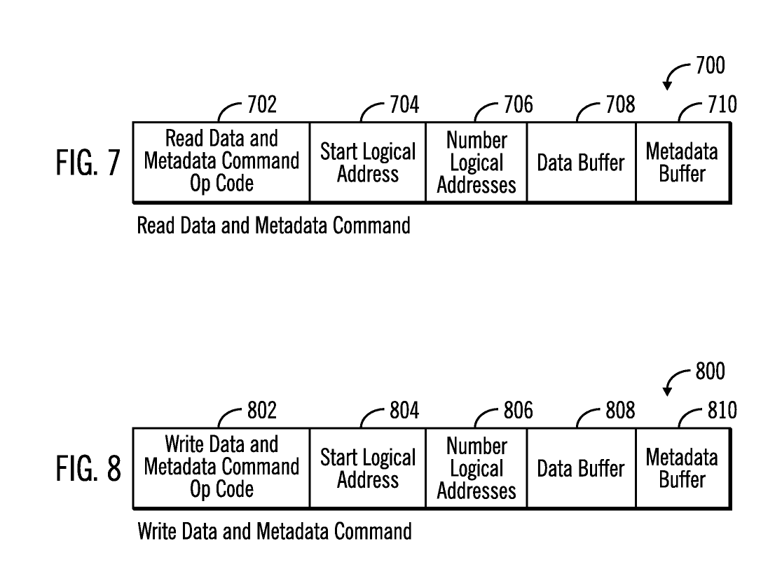

FIG. 7 illustrates an embodiment of a read data and metadata command 700 the cache driver 122 may issue to read data and metadata from the second (extended) size blocks of data in the NVM cache 114, storing both the block of data and metadata. The command 700 includes a read data and metadata command operation (OP) code 702; a start logical address 704 in the NVM cache 114; a number of logical addresses 706 to read; a pointer or identifier to the host data buffer 708 in the cache driver 122 to which the read block of data is transferred; and a pointer or identifier to the host metadata buffer 710 in the cache driver 122 to which the read metadata is transferred. The data buffer 708 and metadata buffer 710 may include a pointer to a location in the data buffer 124 and metadata buffer 126 to which the read block of data and metadata, respectively, are transferred.

FIG. 8 illustrates an embodiment of a write data and metadata command 800 the cache driver 122 may issue to write blocks data and metadata to second (extended) size blocks of data for the cache lines 200ᵢ in the NVM cache 114, storing both the blocks of data and metadata. The command 800 includes a write data and metadata command operation code 802; a start logical address 804 in the NVM cache 114; a number of logical addresses 806 to write; a pointer or identifier to the host data buffer 808 in the cache driver 122 including the write data to transfer; and a pointer or identifier to the host metadata buffer 810 in the cache driver 122 to which the write metadata is transferred. The data buffer 808 and metadata buffer 810 may include a pointer to a location in the buffer 124 and 126 to which blocks of data and metadata, respectively, are buffered to transfer to the NVM cache 114.

FIGS. 7 and 8 show the read and write commands 700 and 800 for both the block of data and metadata for the non-interleaved case, where separate data 124 and metadata 126 buffers are used. In the interleaved case, where the cache driver 122 constructs second (extended) size blocks to transfer, the commands 700 and 800 may only include one pointer, such as the data buffer 708, 808 pointer, and there is no separate metadata buffer 710, 810 indicated in the commands 700 and 800 for the interleaved transfer because the data and metadata are combined in a second size block by the cache driver 122 on the host-side.

The described embodiment commands utilize the extended sector size of data in the NVM cache 114, such that the block of data may comprise a standard first sector size and the block of data and metadata may be stored together in a second size block of the extended (second) sector size in the NVM cache 114. The described commands allow the request of metadata and block of data separately and together to provide a more efficient use of access to minimize data transfer operations, processor utilization and bus bandwidth.

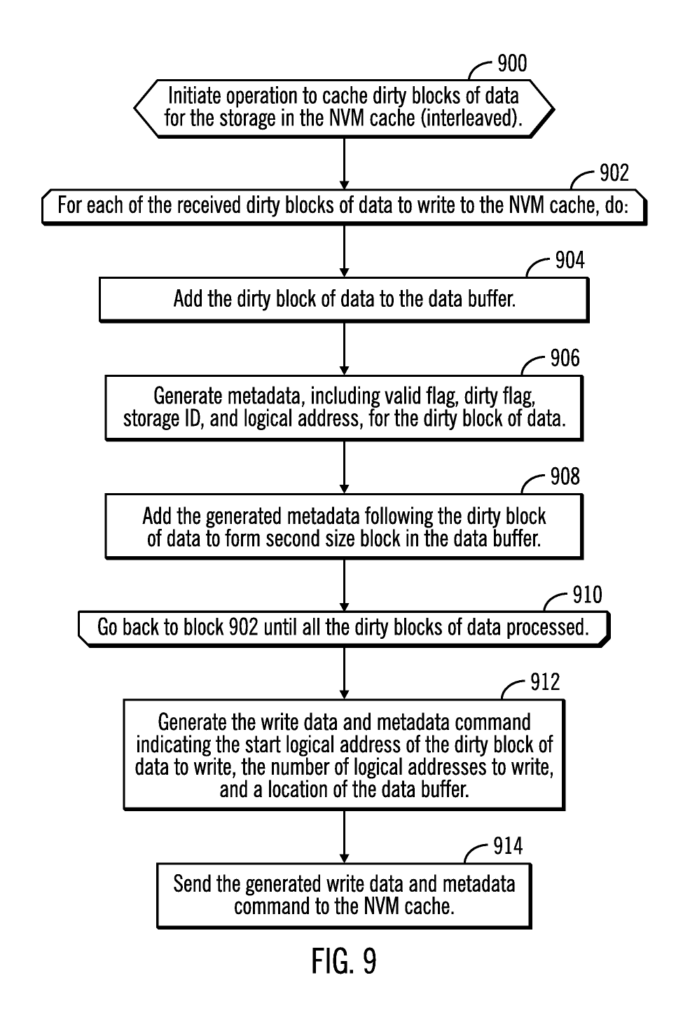

FIG. 9 illustrates an embodiment of operations performed by the cache manager 104 and cache driver 122 to cache dirty blocks of data for the storage 116 in the NVM cache 114 in an interleaved mode such that the blocks of data and metadata data are transferred as a contiguous second size block of data, or the extended size block configured in the NVM cache 114. Upon initiating (at block 900) operations to cache the dirty blocks in the NVM cache 114, the cache manager 104 may then call the cache driver 122 to generate a write data and metadata command 800 to write to a contiguous second size block. The cache driver 122 performs operations at blocks 902 through 910 for each of the dirty blocks of data to write. The cache driver 122 adds (at block 904) a first size block of the block of data 210, for the cache line 200ᵢ to be written to the cache 112, to the data buffer 124. In the interleave mode, only one transfer data buffer 124 is used. The metadata, such as data in fields 202, 204, 206, and 208 is generated (at block 906) and then added (at block 908) following the block of data in the data buffer 124 to form a second (extended) size block in the data buffer 124. In this way, contiguous second size blocks having the block of data and metadata to write are formed in the transfer data buffer 124. After generating second size blocks for all the cache lines 200 to write, the cache driver 122 generates (at block 912) the write data and metadata command 800 indicating the start logical address 804 of the dirty data to write in the cache lines 200, the number of logical addresses to write 806, and the data buffer location 808. For interleaved mode, there is no metadata buffer 810 used because the metadata and blocks of data to transfer are both stored in a second size block in the data buffer 808. The generated write data and metadata command 800 is sent (at block 914) to the NVM cache 114, e.g., SSD, to cache.

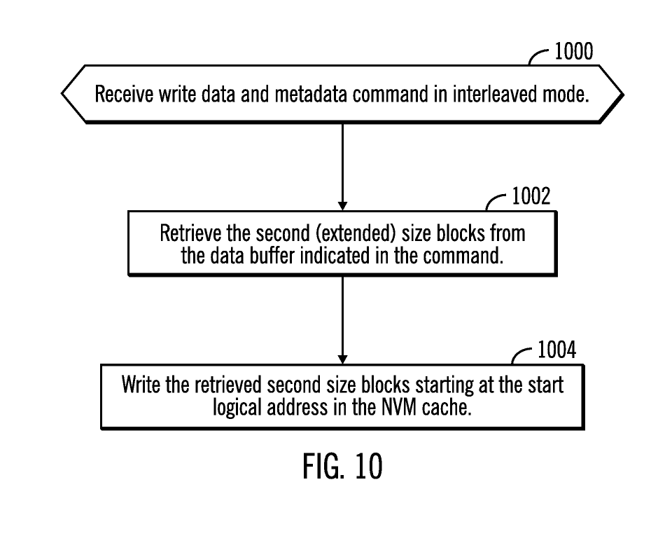

FIG. 10 illustrates an embodiment of operations performed by the NVM controller 130 of the NVM cache 114 to process a received write data and metadata command 800 in interleaved mode. Upon receiving (at block 1000) the write data and metadata command 800, the NVM controller 130 retrieves (at block 1002) the second (extended) size blocks from the data buffer 808 indicated in the received command 800. The retrieved second size blocks, having the second sector size, are written (at block 1004) at the start logical address 804 for the number of logical addresses 806 to the storage dies 132.

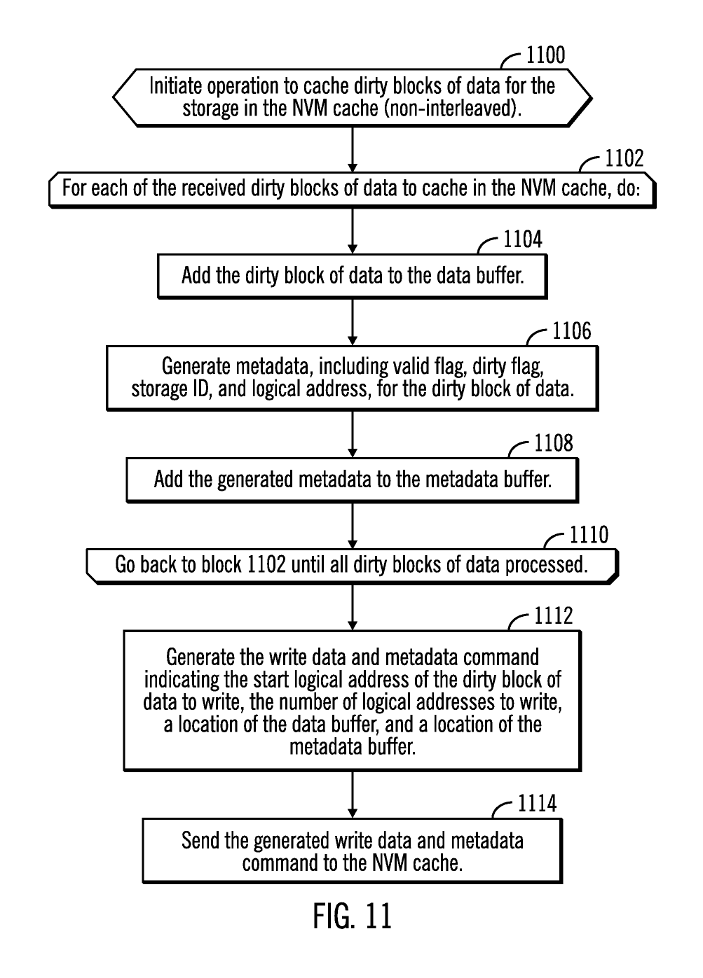

FIG. 11 illustrates an embodiment of operations performed by the cache manager 104 and cache driver 122 to write dirty blocks of data for the storage 116 to cache lines 200 in the NVM cache 114, in a non-interleaved mode, such that the blocks of data and metadata data are not transferred as a contiguous second size block of data formed in the memory 110. Upon initiating (at block 1100) operations to cache dirty blocks of data for the storage 116 in the cache lines 200 in the NVM cache 114, the cache manager 104 may then call the cache driver 122 to generate a write data and metadata command 800 to write the blocks of data and metadata. The cache driver 122 performs operations at blocks 1102 through 1110 for each of the determined cache lines 200 having modified data. The cache driver 122 adds (at block 1104) the first size block of the block of data 210 for the cache line 200ᵢ to the data buffer 124. The metadata, such as data in fields 202, 204, 206, and 208 is gathered (at block 1106) and added (at block 1108) to the metadata buffer 126. After all the blocks of dirty data for the cache lines 200 and the metadata is added to the data 124 and metadata 126 transfer buffers, the cache driver 122 generates (at block 1112) the write data and metadata command 800 indicating the start logical address 804 of the dirty data to write to the cache lines 200 in the NVM cache 114, the number of logical addresses to write 806, the data buffer location 808 having the dirty blocks of data of the logical addresses to write, and the metadata buffer location 810 having the metadata for the dirty blocks of data to write. The generated write data and metadata command 800 is sent (at block 1116) to the NVM cache 114.

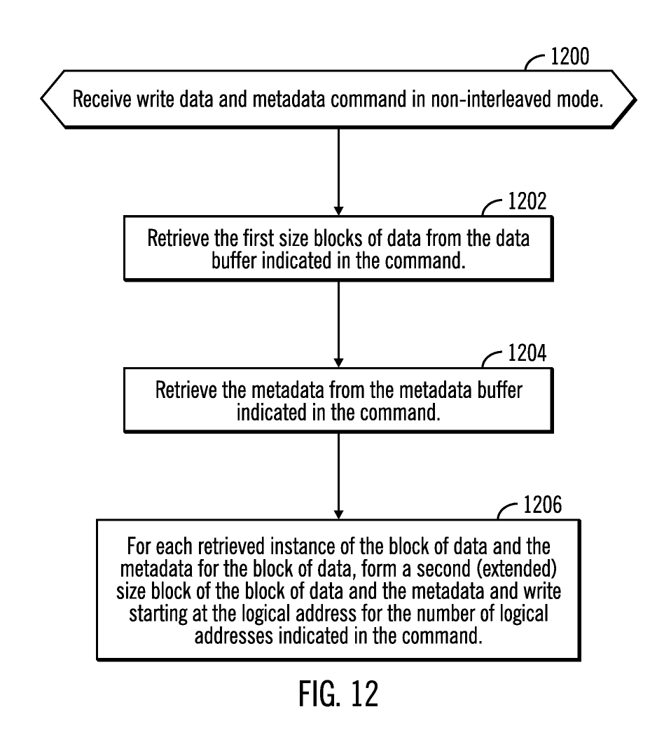

FIG. 12 illustrates an embodiment of operations performed by the NVM controller 130 of the NVM cache 114 to process a received write data and metadata command 800 in non-interleaved mode. Upon receiving (at block 1200) the write data and metadata command 800, the NVM controller 130 retrieves (at block 1202) the first size blocks of data from the data buffer 808 indicated in the received command 800 and retrieves (at block 1204) the metadata from the metadata buffer 810 indicated in the command 810. For each retrieved block of data and the metadata for the block of data, the NVM controller 130 forms (at block 1206) a second (extended) size block of the block of data and the metadata and writes starting at the start logical address 804 for the number of logical addresses 806 in the storage dies 132.

Writing data in non-interleaved mode requires the cache manager 104 to interleave the blocks of data with the metadata, which requires allocating a buffer in the memory 110 large enough to store a second size block of data and metadata. This interleaving requires additional operations and processor utilization. The non-interleaved mode transfers the metadata and blocks of data separately and does not require the interleaving of the data.

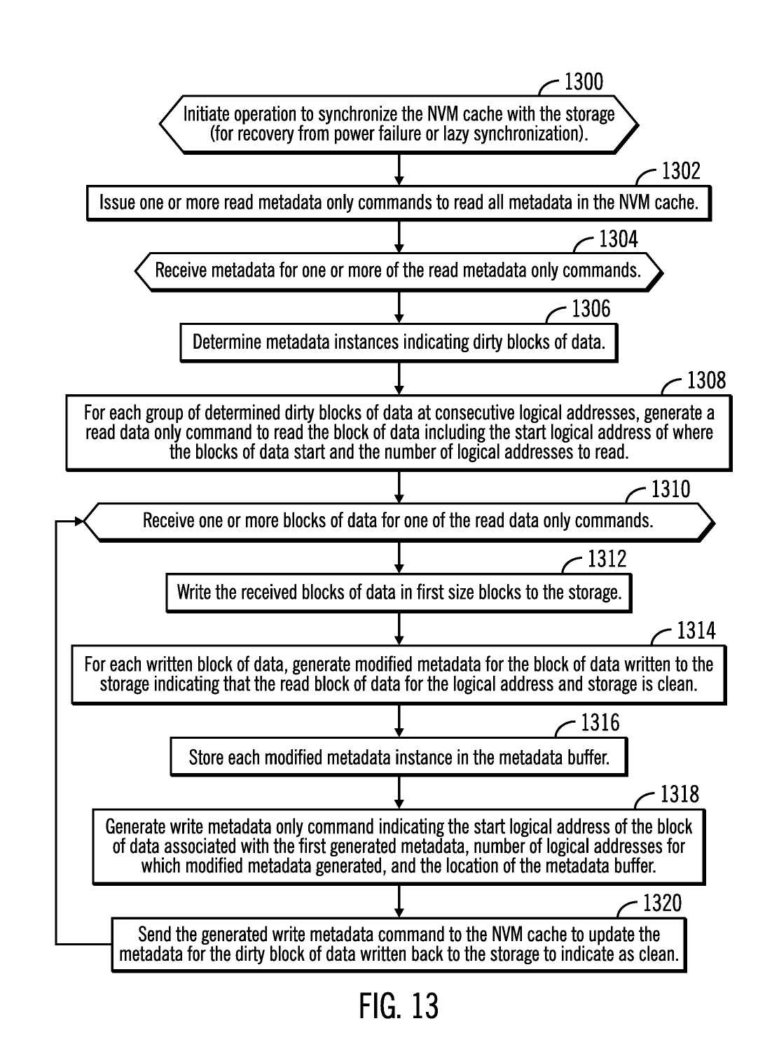

FIG. 13 illustrates an embodiment of operations performed by the cache manager 104 and/or cache driver 122 to synchronize NVM cache 114 with the storage 116, which may be performed after a failure and recovery, or as part of a lazy synchronization to synchronize modified data in the NVM cache 114 to the storage 116 during a period of low I/O activity. Upon initiating an operation to synchronize the NVM cache 114 with the storage 116, the cache manager 104 invokes the cache driver 122 to issue (at block 1302) one or more read metadata only commands 500 to read all metadata in the NVM cache 114. Upon receiving (at block 1304) metadata for the blocks of data at logical addresses in the NVM cache 114 for one or more of the read only metadata commands 500, the metadata instances indicating dirty (e.g., different from the data for the block in the storage 116) blocks of data are determined (at block 1306). For each group of determined dirty blocks of data at consecutive logical addresses, the cache manager 104 calls the cache driver 122 to generate (at block 1308) a read data only command 300 to read the blocks of data including the start logical address 304 of where the blocks of data start and the number of consecutive logical addresses 306 to read.

Upon receiving (at block 1310) one or more instances of blocks of data for one of the read data only commands 300, the cache manager 104 calls the storage driver 128 to write (at block 1312) the read logical blocks of data, having the first block (or sector) size, to the storage 116. For each written block of data to the storage 116, the cache manager 104 generates (at block 1314) modified metadata for the block of data written to the storage 116 indicating that the read block of data for the logical address is clean (e.g., consistent with the data for the block in the storage 116), such as in the dirty flag 204. Each of the generated modified metadata instances are stored in the metadata buffer 126. The cache manager 104 calls the cache driver 122 to generate (at block 1318) a write metadata only command 500 indicating the start logical address 604 of the block of data associated with the first generated metadata, number of consecutive logical addresses 606 for which modified metadata is generated, and the location of the metadata buffer 608. The generated write metadata command 500 is sent to the NVM cache 114 to update the metadata for the cached logical addresses to indicate that the blocks of data for the logical addresses are unmodified, as the data has been synchronized to the storage 116.

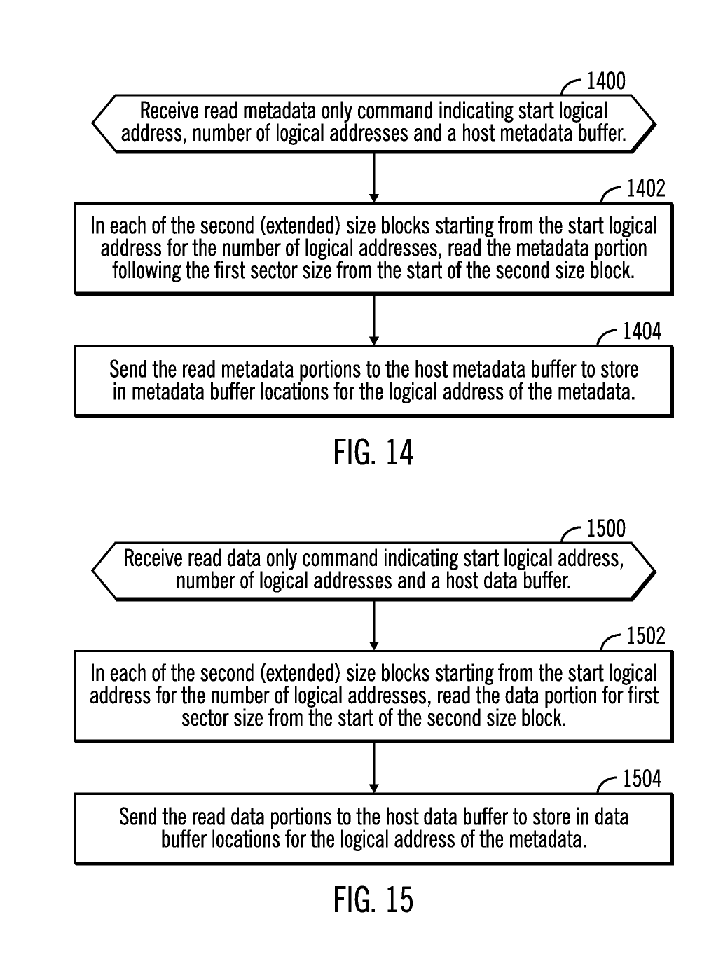

FIG. 14 illustrates an embodiment of operations performed by the NVM controller 130 to process a read metadata only command 500. Upon receiving (at block 1400) the read metadata only command 500 indicating the start logical address 504, number of logical addresses 506 for which metadata is read, and host metadata buffer 508, the NVM controller 130 reads (at block 1402), from each of the second (extended) size blocks starting from the start logical address 504 for the number of logical addresses 506 stored in the storage dies 132, the metadata portion, following the first sector size from the start of the second size block. The read metadata portions are sent (at block 1404) to the host metadata buffer to store in metadata buffer locations for the logical address of the metadata. The processor 102 may then access the metadata in the metadata buffer 126.

FIG. 15 illustrates an embodiment of operations performed by the NVM controller 130 to process a read data only command 300. Upon receiving (at block 1500) the read data only command 300 indicating the start logical address 304, number of logical addresses 306 for which blocks of data are read, and host data buffer 508, the NVM controller 130 reads (at block 1502), from each of the second (extended) size blocks starting from the start logical address 304 for the number of logical addresses 306 in the storage dies 132, the data portion of the first sector size from the start of the second size block. The read data portions are sent (at block 1504) to the host data buffer 124 to store in data buffer locations for the logical address. The processor 102 may then access the blocks of data in the data buffer 124.

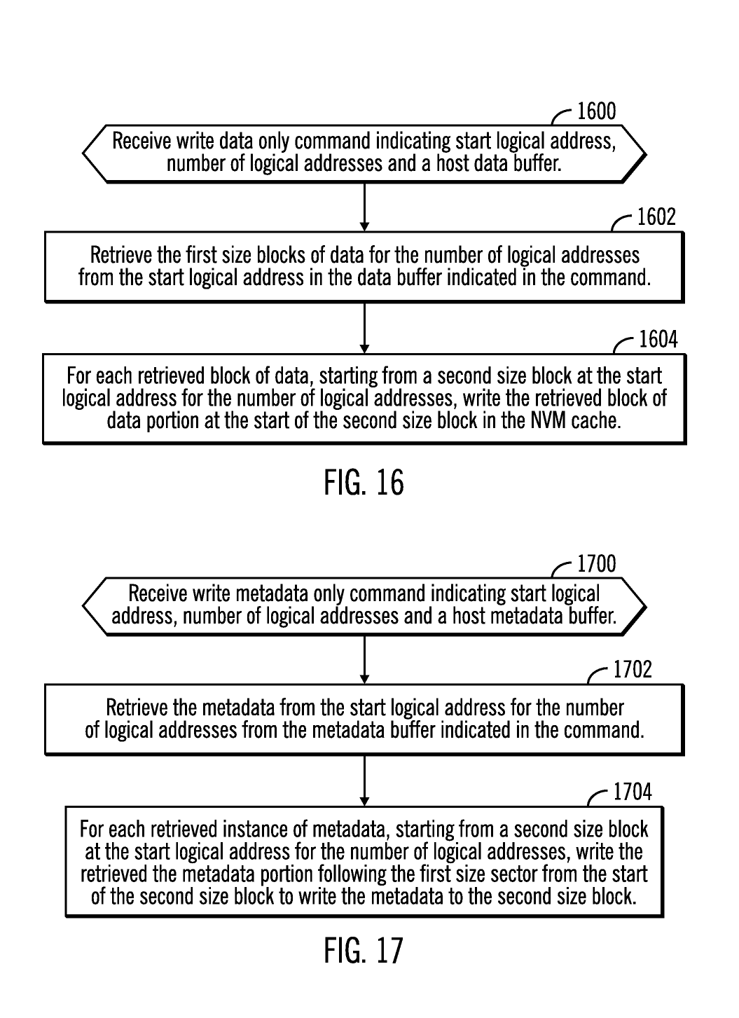

FIG. 16 illustrates an embodiment of operations performed by the NVM controller 130 to process a write data only command 400. Upon receiving (at block 1600) the write data only command 400 indicating the start logical address 404, number of logical addresses 406 for which blocks of data are written, and host data buffer 408, the NVM controller 130 retrieves (at block 1602), the first size blocks of data for the number of logical addresses 406 from the start logical address 404 from the data buffer 408 indicated in the command 400. For each retrieved block of data, starting from a second size block at the start logical address 404 for the number of logical addresses 406, the NVM controller 130 writes (at block 1604) the retrieved data portion (having first sector size) at the start of the second size block to the storage dies 132.

FIG. 17 illustrates an embodiment of operations performed by the NVM controller 130 to process a write metadata only command 600. Upon receiving (at block 1800) the write metadata only command 600 indicating the start logical address 604, number of logical addresses 606 for which metadata instances are written, and host metadata buffer 608, the NVM controller 130 retrieves (at block 1802), the metadata portion for the number of logical addresses 606 from the start logical address 604 from the metadata buffer 608 indicated in the command 600. For each retrieved instance of metadata, starting from a second size block at the start logical address 404 for the number of logical addresses 406, the NVM controller 130 writes (at block 1704) the retrieved metadata portion following the first sector size from the start of the second size block to write the metadata to the second size block in the storage dies 132 in the NVM cache 114.

With the described read and write metadata and data only commands, the cache manager 104 may limit bandwidth and processor cycles by limiting access to a granular level of access to metadata or data only to reduce the amount of data that needs to be retrieved to perform recovery, synchronization, and cache restore operations.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

The reference characters used herein, such as i, are used herein to denote a variable number of instances of an element, which may represent the same or different values, and may represent the same or different value when used with different or the same elements in different described instances.

### Examples

The following examples pertain to further embodiments.

Example 1 is an apparatus to cache blocks of data and metadata for a storage, wherein the storage stores blocks having a first block size, comprising: a non-volatile memory (NVM) cache to cache blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data; a cache manager to: write both the block of data and the metadata for the block of data to one of the blocks in the non-volatile memory cache; and write the block of data in one of the blocks in the non-volatile memory cache to the storage.

In Example 2, the subject matter of examples 1 and 3-10 can optionally include that the metadata for each of the blocks of data indicates whether the block of data in the NVM cache is valid or invalid and modified or unmodified.

In Example 3, the subject matter of examples 1, 2 and 4-10 can optionally include that the block of data and the metadata in the second size block are written to the NVM cache in a single write operation.

In Example 4, the subject matter of examples 1-3 and 5-10 can optionally include that the cache manager is further to: issue a read only metadata command to read only metadata from the NVM cache; determine from the read metadata the blocks of data that are indicated as modified; read only the blocks of data from the NVM cache determined from the read metadata to have modified data; and write only the read block of data to the location in the storage indicated in the read metadata for the read block of data.

In Example 5, the subject matter of examples 1-4 and 6-10 can optionally include that the cache manager is further to: generate modified metadata for the read block of data written to the storage indicating that the read block of data is unmodified; and write only the modified metadata for the read block of data written to the storage to the NVM cache.

In Example 6, the subject matter of examples 1-5 and 7-10 can optionally include that the issue the read only metadata command, the determine from the read metadata, the read only the blocks of data, and the write only the read blocks of data are performed in response to a recovery operation to recover from a power failure at the apparatus.

In Example 7, the subject matter of examples 1-6 and 8-10 can optionally include that the issue the read only metadata command, the determine from the read metadata, the read only the blocks of data, and the write only the read blocks of data are performed as part of a synchronization operation to write modified blocks of data in the NVM cache to the storage.

In Example 8, the subject matter of examples 1-7 and 9-10 can optionally include that the write the second size block having the block of data and the metadata comprises: write to a write buffer blocks of data for multiple cache lines in the NVM cache and the metadata for the blocks of data, wherein the blocks of data are interleaved with the metadata, wherein each block of data interleaved with the metadata combined has the second block size; generate a write command indicating a number of the second size blocks to write and the write buffer with the blocks of data interleaved with the metadata for multiple second size blocks; and transmit the write command to the NVM cache to cause the NVM cache to access the blocks of data interleaved with the metadata in the indicated write buffer to write the second size blocks to the NVM cache.

In Example 9, the subject matter of examples 1-8 and 10 can optionally include that the write the second size block having the block of data and the metadata comprises: write to a data buffer blocks of data for multiple cache lines in the NVM cache; write to a metadata buffer the metadata for the blocks of data written to the data buffer; generate a write command indicating a number of the second size blocks to write, the data buffer, and the metadata buffer; and transmit the write command to the NVM cache to cause the NVM cache to, for each of the number of the second size blocks to write, access the block of data from the indicated write buffer and the metadata from the indicated metadata buffer to write together to a second size block in the NVM cache.

In Example 10, the subject matter of examples 1-9 can optionally include that the NVM cache comprises at least one solid state drive (SSD) configured with blocks having the second block size which comprises an extended block size to configure for the at least one solid state drive, and wherein the NVM cache is a faster access device than the storage.

Example 11 is a system to cache blocks of data and metadata, comprising: a processor; a storage; a non-volatile memory (NVM) cache to cache blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data; a cache manager executed by the processor to: write both the block of data and the metadata for the block of data to one of the blocks in the non-volatile memory cache; and write the block of data in one of the blocks in the non-volatile memory cache to the storage.

In Example 12, the subject matter of claims 11 and 13-18 can optionally include that the metadata for each of the blocks of data indicates whether the block of data in the NVM cache is valid or invalid and modified or unmodified.

In Example 13, the subject matter of claims 11, 12 and 14-18 can optionally include that the block of data and the metadata in the second size block are written to the NVM cache in a single write operation.

In Example 14, the subject matter of claims 11-13 and 15-18 can optionally include that the cache manager is further to: issue a read only metadata command to read only metadata from the NVM cache; determine from the read metadata the blocks of data that are indicated as modified; read only the blocks of data from the NVM cache determined from the read metadata to have modified data; and write only the read block of data to the location in the storage indicated in the read metadata for the read block of data.

In Example 15, the subject matter of claims 11-14 and 16-18 can optionally include that the cache manager is further to: generate modified metadata for the read block of data written to the storage indicating that the read block of data is unmodified; and write only the modified metadata for the read block of data written to the storage to the NVM cache.

In Example 16, the subject matter of claims 11-15 and 17-18 can optionally include that the write the second size block having the block of data and the metadata comprises: write to a write buffer blocks of data for multiple cache lines in the NVM cache and the metadata for the blocks of data, wherein the blocks of data are interleaved with the metadata, wherein each block of data interleaved with the metadata combined has the second block size; generate a write command indicating a number of the second size blocks to write and the write buffer with the blocks of data interleaved with the metadata for multiple second size blocks; and transmit the write command to the NVM cache to cause the NVM cache to access the blocks of data interleaved with the metadata in the indicated write buffer to write the second size blocks to the NVM cache.

In Example 17, the subject matter of claims 11-16 and 18 can optionally include that the write the second size block having the block of data and the metadata comprises: write to a data buffer blocks of data for multiple cache lines in the NVM cache; write to a metadata buffer the metadata for the blocks of data written to the data buffer; generate a write command indicating a number of the second size blocks to write, the data buffer, and the metadata buffer; and transmit the write command to the NVM cache to cause the NVM cache to, for each of the number of the second size blocks to write, access the block of data from the indicated write buffer and the metadata from the indicated metadata buffer to write together to a second size block in the NVM cache.

In Example 18, the subject matter of claims 11-17 can optionally include that the NVM cache comprises at least one solid state drive (SSD) configured with blocks having the second block size which comprises an extended block size to configure for the at least one solid state drive, and wherein the NVM cache is a faster access device than the storage.

Example 19 is a method for caching blocks of data and metadata for a storage in a computer system, comprising: caching, in a non-volatile memory (NVM) cache, blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data; writing both the block of data and the metadata for the block of data to one of the blocks in the non-volatile memory cache; and writing the block of data in one of the blocks in the non-volatile memory cache to the storage.

In Example 20, the subject matter of claims 19 and 21-25 can optionally include that the block of data and the metadata in the second size block are written to the NVM cache in a single write operation.

In Example 21, the subject matter of claims 19, 20 and 22-25 can optionally include that issuing a read only metadata command to read only metadata from the NVM cache; determining from the read metadata the blocks of data that are indicated as modified; reading only the blocks of data from the NVM cache determined from the read metadata to have modified data; and writing only the read block of data to the location in the storage indicated in the read metadata for the read block of data.

In Example 22, the subject matter of claims 19-21 and 23-25 can optionally include generating modified metadata for the read block of data written to the storage indicating that the read block of data is unmodified; and writing only the modified metadata for the read block of data written to the storage to the NVM cache.

In Example 23, the subject matter of claims 19-22 and 24-25 can optionally include that the writing the second size block having the block of data and the metadata comprises: writing to a write buffer blocks of data for multiple cache lines in the NVM cache and the metadata for the blocks of data, wherein the blocks of data are interleaved with the metadata, wherein each block of data interleaved with the metadata combined has the second block size; generating a write command indicating a number of the second size blocks to write and the write buffer with the blocks of data interleaved with the metadata for multiple second size blocks; and transmitting the write command to the NVM cache to cause the NVM cache to access the blocks of data interleaved with the metadata in the indicated write buffer to write the second size blocks to the NVM cache.

In Example 24, the subject matter of claims 19-23 and 25 can optionally include that the writing the second size block having the block of data and the metadata comprises: writing to a data buffer blocks of data for multiple cache lines in the NVM cache; writing to a metadata buffer the metadata for the blocks of data written to the data buffer; generating a write command indicating a number of the second size blocks to write, the data buffer, and the metadata buffer; and transmitting the write command to the NVM cache to cause the NVM cache to, for each of the number of the second size blocks to write, access the block of data from the indicated write buffer and the metadata from the indicated metadata buffer to write together to a second size block in the NVM cache.

In Example 25, the subject matter of claims 19-24 can optionally include that the NVM cache comprises at least one solid state drive (SSD) configured with blocks having the second block size which comprises an extended block size to configure for the at least one solid state drive, and wherein the NVM cache is a faster access device than the storage.

In Example 26, the subject matter as claimed in claim 19, further comprising at least any one of:

(1) wherein the metadata for each of the blocks of data indicates whether the block of data in the NVM cache is valid or invalid and modified or unmodified; and/or

(2) wherein the block of data and the metadata in the second size block are written to the NVM cache in a single write operation; and/or

(3) issuing a read only metadata command to read only metadata from the NVM cache; determining from the read metadata the blocks of data that are indicated as modified; reading only the blocks of data from the NVM cache determined from the read metadata to have modified data; and writing only the read block of data to the location in the storage indicated in the read metadata for the read block of data; and/or

(4) generating modified metadata for the read block of data written to the storage indicating that the read block of data is unmodified; and writing only the modified metadata for the read block of data written to the storage to the NVM cache; and/or

(5) wherein the issue the read only metadata command, the determine from the read metadata, the read only the blocks of data, and the write only the read blocks of data are performed in response to a recovery operation to recover from a power failure at the apparatus; and/or

(6) wherein the issue the read only metadata command, the determine from the read metadata, the read only the blocks of data, and the write only the read blocks of data are performed as part of a synchronization operation to write modified blocks of data in the NVM cache to the storage; and/or

(7) wherein the writing the second size block having the block of data and the metadata comprises: writing to a write buffer blocks of data for multiple cache lines in the NVM cache and the metadata for the blocks of data, wherein the blocks of data are interleaved with the metadata, wherein each block of data interleaved with the metadata combined has the second block size; generating a write command indicating a number of the second size blocks to write and the write buffer with the blocks of data interleaved with the metadata for multiple second size blocks; and transmitting the write command to the NVM cache to cause the NVM cache to access the blocks of data interleaved with the metadata in the indicated write buffer to write the second size blocks to the NVM cache; and/or

(8) wherein the writing the second size block having the block of data and the metadata comprises: writing to a data buffer blocks of data for multiple cache lines in the NVM cache; writing to a metadata buffer the metadata for the blocks of data written to the data buffer; generating a write command indicating a number of the second size blocks to write, the data buffer, and the metadata buffer; and transmitting the write command to the NVM cache to cause the NVM cache to, for each of the number of the second size blocks to write, access the block of data from the indicated write buffer and the metadata from the indicated metadata buffer to write together to a second size block in the NVM cache; and/or

(9) wherein the NVM cache comprises at least one solid state drive (SSD) configured with blocks having the second block size which comprises an extended block size to configure for the at least one solid state drive, and wherein the NVM cache is a faster access device than the storage.

Example 27 is an apparatus for caching blocks of data and metadata for a storage in a computer system, comprising: means for caching, in a non-volatile memory (NVM) cache, blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data; means for writing both the block of data and the metadata for the block of data to one of the blocks in the non-volatile memory cache; and means for writing the block of data in one of the blocks in the non-volatile memory cache to the storage.

Example 28 is a machine-readable storage including machine-readable instructions, when executed, to implement a method or realize an apparatus as claimed in any preceding claim.

What is claimed:

1. An apparatus to cache blocks of data and metadata for a storage, wherein the storage stores blocks having a first block size, comprising:
a non-volatile memory (NVM) cache to cache blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data;
a cache manager to:
write both the block of data and the metadata for the block of data to one of the blocks in the non-volatile memory cache; and
write the block of data in one of the blocks in the non-volatile memory cache to the storage.

2. The apparatus of claim 1, wherein the metadata for each of the blocks of data indicates whether the block of data in the NVM cache is valid or invalid and modified or unmodified.

3. The apparatus of claim 1, wherein the block of data and the metadata in the second size block are written to the NVM cache in a single write operation.

4. The apparatus of claim 1, wherein cache manager is further to:
issue a read only metadata command to read only metadata from the NVM cache;
determine from the read metadata the blocks of data that are indicated as modified;
read only the blocks of data from the NVM cache determined from the read metadata to have modified data; and
write only the read block of data to the location in the storage indicated in the read metadata for the read block of data.

5. The apparatus of claim 4, wherein the cache manager is further to:
generate modified metadata for the read block of data written to the storage indicating that the read block of data is unmodified; and
write only the modified metadata for the read block of data written to the storage to the NVM cache.

6. The apparatus of claim 4, wherein the issue the read only metadata command, the determine from the read metadata, the read only the blocks of data, and the write only the read blocks of data are performed in response to a recovery operation to recover from a power failure at the apparatus.

7. The apparatus of claim 4, wherein the issue the read only metadata command, the determine from the read metadata, the read only the blocks of data, and the write only the read blocks of data are performed as part of a synchronization operation to write modified blocks of data in the NVM cache to the storage.

8. The apparatus of claim 1, wherein the write the second size block having the block of data and the metadata comprises:
write to a write buffer blocks of data for multiple cache lines in the NVM cache and the metadata for the blocks of data, wherein the blocks of data are interleaved with the metadata, wherein each block of data interleaved with the metadata combined has the second block size;
generate a write command indicating a number of the second size blocks to write and the write buffer with the blocks of data interleaved with the metadata for multiple second size blocks; and
transmit the write command to the NVM cache to cause the NVM cache to access the blocks of data interleaved with the metadata in the indicated write buffer to write the second size blocks to the NVM cache.

9. The apparatus of claim 1, wherein the write the second size block having the block of data and the metadata comprises:
write to a data buffer blocks of data for multiple cache lines in the NVM cache;
write to a metadata buffer the metadata for the blocks of data written to the data buffer;
generate a write command indicating a number of the second size blocks to write, the data buffer, and the metadata buffer; and
transmit the write command to the NVM cache to cause the NVM cache to, for each of the number of the second size blocks to write, access the block of data from the indicated write buffer and the metadata from the indicated metadata buffer to write together to a second size block in the NVM cache.

10. The apparatus of claim 1, wherein the NVM cache comprises at least one solid state drive (SSD) configured with blocks having the second block size which comprises an extended block size to configure for the at least one solid state drive, and wherein the NVM cache is a faster access device than the storage.

11. A system,
a processor;
a storage;
a non-volatile memory (NVM) cache to cache blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data;
a cache manager to:
write both the block of data and the metadata for the block of data to one of the blocks in the non-volatile memory cache; and
write the block of data in one of the blocks in the non-volatile memory cache to the storage.

12. The system of claim 11, wherein the metadata for each of the blocks of data indicates whether the block of data in the NVM cache is valid or invalid and modified or unmodified.

13. The system of claim 11, wherein the block of data and the metadata in the second size block are written to the NVM cache in a single write operation.

14. The system of claim 11, wherein cache manager is further to:
issue a read only metadata command to read only metadata from the NVM cache;
determine from the read metadata the blocks of data that are indicated as modified;
read only the blocks of data from the NVM cache determined from the read metadata to have modified data; and
write only the read block of data to the location in the storage indicated in the read metadata for the read block of data.

15. The system of claim 14, wherein the cache manager is further to:
generate modified metadata for the read block of data written to the storage indicating that the read block of data is unmodified; and
write only the modified metadata for the read block of data written to the storage to the NVM cache.

16. The system of claim 11, wherein the write the second size block having the block of data and the metadata comprises:
write to a write buffer blocks of data for multiple cache lines in the NVM cache and the metadata for the blocks of data, wherein the blocks of data are interleaved with the metadata, wherein each block of data interleaved with the metadata combined has the second block size;
generate a write command indicating a number of the second size blocks to write and the write buffer with the blocks of data interleaved with the metadata for multiple second size blocks; and
transmit the write command to the NVM cache to cause the NVM cache to access the blocks of data interleaved with the metadata in the indicated write buffer to write the second size blocks to the NVM cache.

17. The system of claim 11, wherein the write the second size block having the block of data and the metadata comprises:
write to a data buffer blocks of data for multiple cache lines in the NVM cache;
write to a metadata buffer the metadata for the blocks of data written to the data buffer;
generate a write command indicating a number of the second size blocks to write, the data buffer, and the metadata buffer; and
transmit the write command to the NVM cache to cause the NVM cache to, for each of the number of the second size blocks to write, access the block of data from the indicated write buffer and the metadata from the indicated metadata buffer to write together to a second size block in the NVM cache.

18. The system of claim 11, wherein the NVM cache comprises at least one solid state drive (SSD) configured with blocks having the second block size which comprises an extended block size to configure for the at least one solid state drive, and wherein the NVM cache is a faster access device than the storage.

19. A method for caching data in a computer system, comprising:
caching, in a non-volatile memory (NVM) cache, blocks of data from the storage of the first block size and metadata for each of the cached blocks of data indicating a status of the cached block of data, including whether the block of data is modified or unmodified, and a location in the storage where the block of data is stored, wherein the non-volatile memory has blocks of a second block size greater than the first block size, wherein one of the blocks in the non-volatile memory stores the block of data from the storage and the metadata for the block of data;
writing both the block of data and the metadata for the block of data to one of the blocks in the non-volatile memory cache; and
writing the block of data in one of the blocks in the non-volatile memory cache to the storage.

20. The method of claim 19, wherein the block of data and the metadata in the second size block are written to the NVM cache in a single write operation.

21. The method of claim 19, further comprising:
issuing a read only metadata command to read only metadata from the NVM cache;
determining from the read metadata the blocks of data that are indicated as modified;
reading only the blocks of data from the NVM cache determined from the read metadata to have modified data; and
writing only the read block of data to the location in the storage indicated in the read metadata for the read block of data.

22. The method of claim 21, further comprising:
generating modified metadata for the read block of data written to the storage indicating that the read block of data is unmodified; and
writing only the modified metadata for the read block of data written to the storage to the NVM cache.

23. The method of claim 19, wherein the writing the second size block having the block of data and the metadata comprises:
writing to a write buffer blocks of data for multiple cache lines in the NVM cache and the metadata for the blocks of data, wherein the blocks of data are interleaved with the metadata, wherein each block of data interleaved with the metadata combined has the second block size;
generating a write command indicating a number of the second size blocks to write and the write buffer with the blocks of data interleaved with the metadata for multiple second size blocks; and
transmitting the write command to the NVM cache to cause the NVM cache to access the blocks of data interleaved with the metadata in the indicated write buffer to write the second size blocks to the NVM cache.

24. The method of claim 19, wherein the writing the second size block having the block of data and the metadata comprises:
writing to a data buffer blocks of data for multiple cache lines in the NVM cache;
writing to a metadata buffer the metadata for the blocks of data written to the data buffer;
generating a write command indicating a number of the second size blocks to write, the data buffer, and the metadata buffer; and
transmitting the write command to the NVM cache to cause the NVM cache to, for each of the number of the second size blocks to write, access the block of data from the indicated write buffer and the metadata from the indicated metadata buffer to write together to a second size block in the NVM cache.

25. The method of claim 19, wherein the NVM cache comprises at least one solid state drive (SSD) configured with blocks having the second block size which comprises an extended block size to configure for the at least one solid state drive, and wherein the NVM cache is a faster access device than the storage.
